(19) United States
(12) Patent Application Publication
(10) Pub. No.: US 2011/0146377 A1
(43) Pub. Date: Jun. 23, 2011

(54) Impact Generator and Impact Testing Platform

(76) Inventor: Kun Ta Lee, Taipei Hsien (TW)

(21) Appl. No.: 12/753,191

(22) Filed: Apr. 2, 2010

(30) Foreign Application Priority Data
Dec. 21, 2009 (TW) 98143872

(51) Int. Cl. G01N 3/317

(52) U.S. Cl. 73/12.09

(57) ABSTRACT

An impact generator and an impact testing platform using the impact generator are provided. The impact generator has an axial direction, a radial direction and a tangential direction, which are substantially orthogonal to each other. The impact generator comprises a coil and a magnetic device. The coil winds around along the axial direction. The magnetic device is adjacent to the coil and configured to construct a magnetic field so that a plurality of magnetic field lines of the magnetic field all pass through the coil substantially along the radial direction. The current flows along the tangential direction in the coil substantially so that the magnetic device is actuated by a force along the axial direction and generates an impact outwards while a current is conducted into the coil.

This application claims the benefit from the priority of Taiwan Patent Application No. 098143872 filed on Dec. 21, 2009, and the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to an impact generator, and more particularly, to an impact generator for use in an impact testing platform.

2. Descriptions of the Related Art

With the development of science and technology over recent years, more products have become available in the market. To be competitive, each manufacturer must improve the durability of its products to attract consumers to purchase the products. Manufactures often use an impact testing platform to test the impact endurance and service life of their products. A conventional impact testing platform generates an impact of an unspecific magnitude and an unspecific frequency by means of at least one air hammer to test the impact endurance of products that are fastened to the impact testing platform. However, the air hammer cannot generate an impact of a specific magnitude and a specific frequency because of characteristics thereof, making it difficult for product manufacturers to accurately test the endurance of products under the test against an impact of a specific impact form, a specific magnitude and a specific frequency.

In view of this, it is important to provide an impact generator that can generate an impact of a specific magnitude and a specific frequency.

### SUMMARY OF THE INVENTION

An objective of the present invention is to provide an impact generator which can generate an impact force of a specific magnitude and a specific frequency through the interaction of a coil with a magnetic device to accurately test an object.

Another objective of the present invention is to provide an impact generator which can deliver a higher energy conversion efficiency through the interaction of a coil with a magnetic device to generate a greater impact force.

To achieve the aforesaid objectives, the impact generator of the present invention comprises a coil and a magnetic device. The coil winds around along an axial direction. The magnetic device is disposed adjacent to the coil and configured to construct a magnetic field, so that a plurality of magnetic field lines of the magnetic field all pass through the coil substantially along a radial direction. After being conducted into the coil, the current substantially flows along a tangential direction so that the magnetic device is actuated by a force along the axial direction and generates an impact outwards.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of an impact generator according to the present invention;

FIG. 2 is a schematic view of a second embodiment of the impact generator according to the present invention; and

FIG. 3 is a schematic view of a third embodiment of the impact generator according to the present invention.

### DESCRIPTION OF THE PREFERRED EMBODIMENT

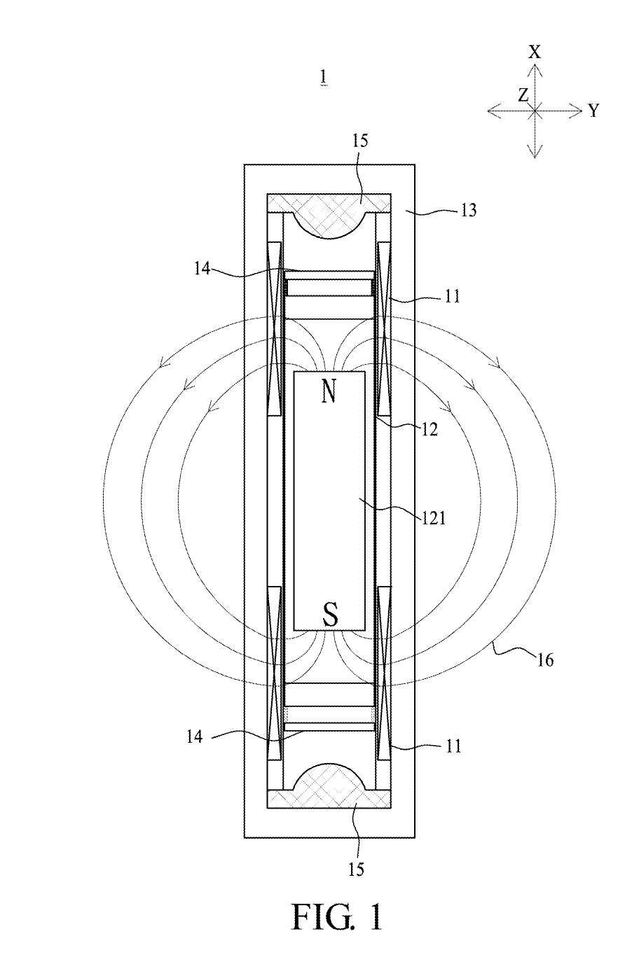

FIG. 1 is a schematic view of the first embodiment of an impact generator 1 according to the present invention. The impact generator 1 defines an axial direction X, a radial direction Y and a tangential direction Z, which are all substantially orthogonal to each other. The impact generator 1 comprises a coil 11 and a magnetic device 12. The coil 11 winds around along the axial direction X. The magnetic device 12 is disposed adjacent to the coil 11 and configured to construct a magnetic field, so that a plurality of magnetic field lines 16 of the magnetic field all pass through the coil 11 substantially along the radial direction Y. When a current (not shown) is conducted into the coil 11 and the current flows substantially along the tangential direction Z in the coil 11, the magnetic device 12 is actuated by a force along the axial direction X and generates an impact outwards. The impact generator 1 is adapted to be fastened with a plate of an impact testing platform (not shown) to perform an impact test on an object that is fastened to the platform of the impact testing platform.

Specifically, in the first embodiment, the impact generator 1 comprises two coils 11 and the magnetic device 12 comprises at least one magnetic element 121. The impact generator 1 further comprises a magnetically conductive housing 13, two impact elements 14 and two buffer elements 15. The magnetically conductive housing 13 is adapted to enhance the magnetic field and receive the coils 11 and the magnetic device 12. The two coils 11 are both fastened with the housing 13. The two impact elements 14 are respectively disposed on two ends of the magnetic element 121 which are arranged along the axial direction X, and the two buffer elements 15 are disposed inside the housing 13 and opposite the two impact elements 14 respectively. When the current is conducted into the coils 11 and the magnetic device 12 is consequently moved, the two buffer elements 15 are adapted to receive impact from the two impact elements 14 respectively.

The method in which the impact generator 1 of the first embodiment is operated will be described in detail hereinafter. Again, in reference to FIG. 1, the upper end of the magnetic element 121 is an N pole, while the lower end of the magnetic element 121 is an S pole. The magnetic element 121 is adapted to construct a polarized direction parallel to the axial direction X. The two coils 11 are adapted to enclose the upper and the lower ends of the magnetic element 121 respectively. When a current is conducted into the coils 11, the current will flow clockwise or counterclockwise along the axial direction X as the coils 11 wind around along the axial direction X. If, for example, the current direction is counterclockwise, then the right side of the upper coil 11 above the magnetic device 12 has a current perpendicularly passing into the paper plane along the tangential direction Z. The magnetic field lines 16 pass through the upper coil 11 rightwards along the radial direction Y. In this case, according to Fleming's left hand rule, the magnetic field will induce a downward acting force to the upper coil 11 along the axial direction X. As the coils 11 are fastened to the housing 13, the magnetic device 12 opposite the upper coil 11 will be actuated to move upwards along the axial direction X by a counterforce that is generated along the axial direction X. As a result, the impact element 14 located above the magnetic device 12 impacts the upper buffer element 15, thereby generating an impact outwards.

It should be appreciated that in the drawings and the aforesaid description, the polarized direction of the magnetic element 121 and the aforesaid flowing direction of the current are only provided to illustrate the possible statuses of this embodiment; those of ordinary skill in the art may reverse the polarized direction of the magnetic element 121 and/or introduce a current of an opposite flowing direction according to the spirits of the present invention, in which case an impact force outwards may also be generated by the magnetic device 121 of the impact generator 1 according to Fleming's left hand rule.

In the first embodiment of the impact generator 1 according to the present invention, the magnetic element 121 may have two sub magnetic elements. The two sub magnetic elements are disposed along the axial direction X sequentially, and are disposed adjacent to the two coils 11 respectively to jointly construct a magnetic field with the same characteristics described above. Similarly, as a result of the flow of the current, the two sub magnetic elements of the magnetic device 12 are actuated by a force along the axial direction X to generate an impact outwards. In this example, the original magnetic element 121 is replaced by the two sub magnetic elements. Otherwise, the relative positions of other elements all remain unchanged, so corresponding operating principles will not be described again herein.

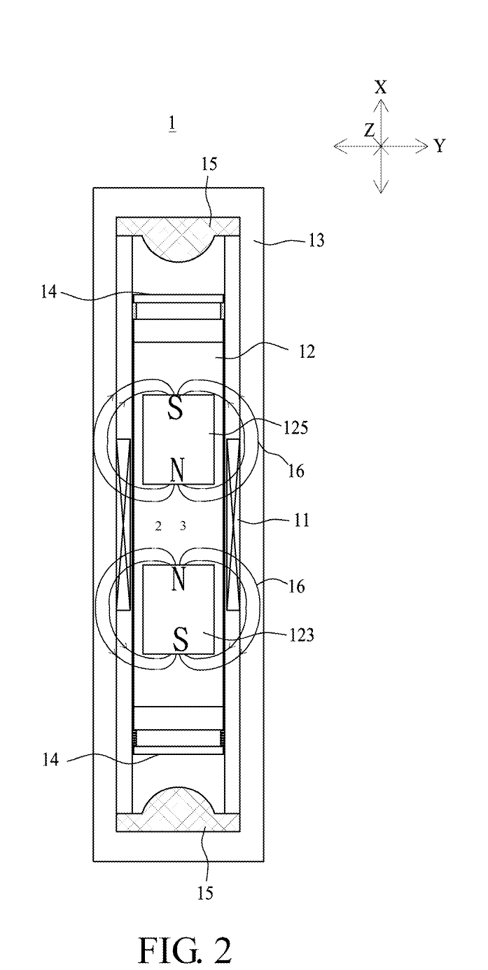

The second embodiment of the impact generator 1 according to the present invention is shown in FIG. 2. In this embodiment, the impact generator 1 comprises a single coil 11 and a magnetic device 12. Like the first embodiment, the impact generator 1 comprises a magnetically conductive housing 13, two impact elements 14 and two buffer elements 15. In the second embodiment, the magnetic device 12 comprises a first magnetic element 123 and a second magnetic element 125. As shown in FIG. 2, the first magnetic element 123 and the second magnetic element 125 are disposed along the axial direction X sequentially, and have two polarized directions parallel to the axial direction X and opposite each other respectively. In an example, a first end of the first magnetic element 123 is an N pole, and is disposed adjacent to and facing a second end of the second magnetic element 125 which is an N pole. The coil 11 is adapted to enclose the first end (i.e., the N pole) of the first magnetic element 123 and the second end (i.e., the N pole) of the second magnetic element 125. The two impact elements 14 are disposed on one end of the first magnetic element 123 and one end of the second magnetic element 125 respectively, with the two ends disposed along the axial direction X and directed away from each other. The positional relationship between the housing 13 and the two buffer elements 15 are just identical to that of the first embodiment, and this will not be further described herein.

The method in which the impact generator 1 of the second embodiment is operated will be described in detail hereinafter. Again, in reference to FIG. 2, the coil 11 encloses the first end (i.e., the N pole) of the first magnetic element 123 and the second end (i.e., the N pole) of the second magnetic element 125. In the following example, a current flows counterclockwise along the axial direction X and is conducted into the coil 11. When a current perpendicularly flowing into the paper plane along the tangential direction Z is conducted into the right side of the coil 11, the magnetic field lines 16 of both the first magnetic element 123 and the second magnetic element 125 pass through the coil 11 rightwards along the radial direction Y; in this case, according to Fleming's left hand rule, the magnetic fields of the first magnetic element 123 and the second magnetic element 125 will induce an acting force that tends to move the coil 11 downwards along the axial direction X. As the coil 11 is fastened to the housing 13, both the first magnetic element 123 and the second magnetic element 125 opposite the coil 11 will be actuated by a counterforce to move upwards along the axial direction X. As a result, the impact elements 14 located above the magnetic device 12 impact the upper buffer elements 15, thereby generating an impact force outwards.

It should be appreciated that in the drawings and the aforesaid description, the polarized direction of the first magnetic element 123 and the second magnetic element 125 and the aforesaid flowing direction of the current are only provided to illustrate the possible statuses of this embodiment; those of ordinary skill in the art may reverse the polarized direction of the first magnetic element 123 and the second magnetic element 125 and/or introduce a current of an opposite flowing direction according to the spirits of the present invention, in which case an impact force outwards may also be generated by the first magnetic element 123 and the second magnetic element 125 of the impact generator 1 according to Fleming's left hand rule.

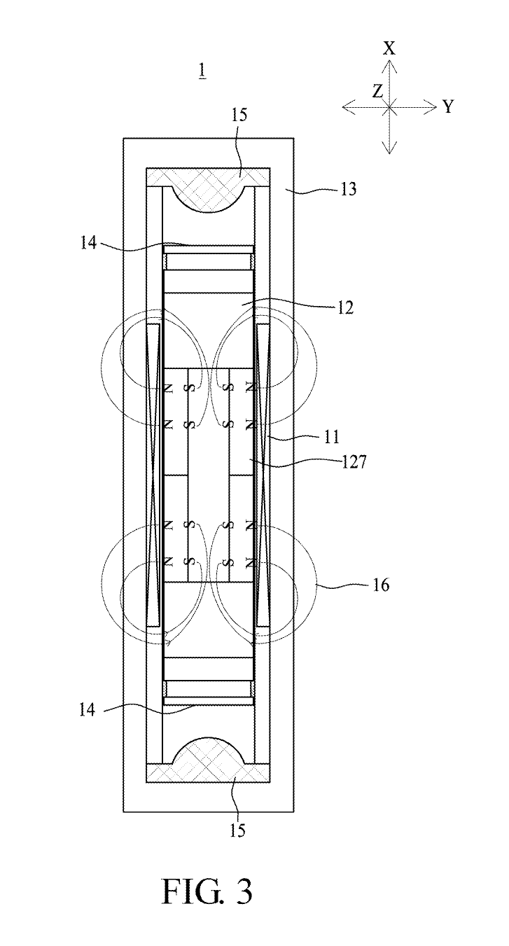

The third embodiment of the impact generator 1 according to the present invention is shown in FIG. 3. The impact generator 1 comprises a single coil 11 and a magnetic device 12. Similar to the aforesaid embodiments, the impact generator 1 comprises a housing 13, two impact elements 14 and two buffer elements 15. The positional relationship of the housing 13, the two impact elements 14 and the two buffer elements 15 are just identical to that of the first embodiment, and this will not be described again herein. The magnetic device 12 comprises at least one magnetic element 127 with a polarized direction parallel to the radial direction Y and is preferably shaped as a hollow tube. The coil 11 encloses at least one middle portion of the magnetic element 127. In this embodiment, the inner side of the magnetic element 127 shaped as a hollow tube may be an S pole, while the outer side of the magnetic element 127 shaped as a hollow tube may be an N pole. As shown in FIG. 3, the magnetic element 127 of this embodiment may comprise two sub magnetic elements shaped as hollow tubes that are disposed side by side along the axial direction X sequentially.

The method in which the impact generator 1 of the third embodiment is operated will be described in detail hereinafter. Again, in reference to FIG. 3, the coil 11 encloses the middle portion of the magnetic element 127 shaped as a hollow tube, and the magnetic element 127 is adapted to construct a magnetic field with a plurality of magnetic field lines 16 passing through the coil 11 outwards along the radial direction Y. In the following example, a current flows counterclockwise along the axial direction X and is conducted into the coil 11. When a current perpendicularly flowing into the paper plane along the tangential direction Z is conducted into the right side of the coil 11, the magnetic field lines 16 of the magnetic element 127 pass through the coil 11 rightwards along the radial direction Y; in this case, according to Fleming's left hand rule, the magnetic field of the magnetic element 127 will induce a downwards acting force to the coil 11 along the axial direction X. As the coil 11 is fastened to the housing 13, the magnetic element 127 opposite the coil 11 will be actuated by a counterforce to move upwards along the axial direction X. As a result, the impact elements 14 located above the magnetic device 12 impact the upper buffer elements 15, thereby generating an impact outwards.

It should be appreciated that in the drawings and the aforesaid description, the polarized direction of the magnetic element 127 and the aforesaid flowing direction of the current are only provided to illustrate the possible statuses of this embodiment; those of ordinary skill in the art may reverse the polarized direction of the magnetic element 127 and/or introduce a current of an opposite flowing direction according to the spirits of the present invention, in which case an impact force outwards may also be generated by the magnetic device 127 of the impact generator 1 according to Fleming's left hand rule.

According to the above description, in the impact generator 1 of the present invention, the magnetic device 12 is moved by a generated force according to Fleming's left hand rule, through the interaction between the current direction and the magnetic field direction orthogonal to each other. Thereby, with the magnetic field strength remaining constant, an impact force of a specific magnitude can be generated by the magnetic device 12 through the adjustment of the current magnitude and turn number of the coil(s). This overcomes the shortcoming of the prior art that the air hammer cannot generate an impact of a specific magnitude and a specific frequency, which makes it difficult for manufactures to accurately test the endurance of a product under a test against an impact of a specific impact form, a specific magnitude and a specific frequency. It should be noted that in the aforesaid embodiments, the numbers and arrangement of the magnetic element(s) in the magnetic device are just provided to illustrate the technical features of the impact generator of the present invention but not to limit the present invention. Modifications in the numbers and related arrangement may be readily made by those of ordinary skill in the art according to the spirits of the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An impact generator, defining an axial direction, a radial direction and a tangential direction substantially orthogonal to each others, the impact generator comprising:
a coil winding around along the axial direction; and
a magnetic device being disposed adjacent to the coil and configured to construct a magnetic field, in which a plurality of magnetic field lines of the magnetic field pass through the coil substantially all along the radial direction;
wherein while a current is conducted into the coil and the current flows substantially along the tangential direction in the coil, the magnetic device is actuated by a force along the axial direction and generates an impact outward.

2. The impact generator as claimed in claim 1, wherein the impact generator comprises two of the coils, the magnetic device comprises a magnetic element, the magnetic element has two ends arranged along the axial direction and a polarized direction parallel to the axial direction, and the coils are adapted to enclose the ends of the magnetic element respectively.

3. The impact generator as claimed in claim 2, wherein the impact generator further comprises a magnetically conductive housing adapted to enhance the magnetic field and receive the coils and the magnetic device, and the coils are fastened with the housing.

4. The impact generator as claimed in claim 3, wherein the impact generator further comprises two impact elements disposed on the ends respectively.

5. The impact generator as claimed in claim 4, wherein the impact generator further comprises two buffer elements disposed inside the housing and opposite the impact elements respectively, and the buffer elements are impacted by the impact elements.

6. The impact generator as claimed in claim 2, wherein the magnetic element comprises two sub magnetic elements disposed along the axial direction sequentially.

7. The impact generator as claimed in claim 1, wherein the magnetic device comprises a first magnetic element and a second magnetic element disposed along the axial direction sequentially, the first magnetic element and the second magnetic element have two polarized directions parallel to the axial direction and opposite each other respectively, a first end of the first magnetic element and a second end of the second magnetic element are adjacent and face to each other, and the coil is adapted to enclose the first end of the first magnetic element and the second end of the second magnetic element.

8. The impact generator as claimed in claim 7, wherein the impact generator further comprises a magnetically conductive housing adapted to enhance the magnetic field and receive the coil and the magnetic device, and the coil is fastened with the housing.

9. The impact generator as claimed in claim 8, wherein the impact generator further comprises two impact elements, the first magnetic element and the second magnetic element have two ends respectively, the two ends are disposed along the axial direction and away from each other, and the impact elements are disposed on the ends respectively.

10. The impact generator as claimed in claim 9, wherein the impact generator further comprises two buffer elements disposed inside the housing and opposite the impact elements respectively, and the buffer elements are impacted by the impact elements.

11. The impact generator as claimed in claim 1, wherein the magnetic device comprises a magnetic element with a polarized direction parallel to the radial direction, and the coil at least encloses a middle portion of the magnetic element.

12. The impact generator as claimed in claim 11, wherein the magnetic element is shaped as a hollow tube.

13. The impact generator as claimed in claim 12, wherein the impact generator further comprises a magnetically conductive housing adapted to enhance the magnetic field and receive the coil and the magnetic device, and the coil is fastened with the housing.

14. The impact generator as claimed in claim 13, wherein the impact generator further comprises two impact elements, the magnetic element has two ends along the axial direction, and the impact elements are disposed on the ends respectively.

15. The impact generator as claimed in claim 14, wherein the impact generator further comprises two buffer elements disposed inside the housing and opposite the impact elements respectively, and the buffer elements are impacted by the impact elements.

16. The impact generator as claimed in claim 12, wherein the magnetic element comprises two sub magnetic elements disposed along the axial direction sequentially.

17. An impact testing platform, comprising:
an impact generator as claimed in claim 1, and
a platform fastened with the impact generator.
